(19) United States
(12) Patent Application Publication
(10) Pub. No.: US 2012/0240597 A1
(43) Pub. Date: Sep. 27, 2012

(54) TEMPERATURE CONTROL APPARATUS FOR SAMPLES STORAGE

(75) Inventors: Jin-Kwang HONG, Changwon-city (KR); Sung-Hun LEE, Changwon-city (KR)

(73) Assignee: SAMSUNG TECHWIN CO., LTD., Changwon-city (KR)

(21) Appl. No.: 13/424,432

(22) Filed: Mar. 20, 2012

(30) Foreign Application Priority Data
Mar. 22, 2011 (KR) 10-2011-0025392

(51) Int. Cl. G05D 23/00; F25B 21/02

(52) U.S. Cl. 62/3.6; 165/287

(57) ABSTRACT

A temperature control apparatus for sample storage includes: a well block comprising at least one accommodation groove accommodating at least one container for containing at least one sample therein, respectively; and a temperature control unit controlling a respective temperature of the at least one sample to be uniform, wherein the temperature control unit includes: a heat source portion generating heat or cold; and a heat transfer object transferring the heat or the cold of the heat source portion to the well block.

### CROSS-REFERENCE TO RELATED PATENT APPLICATION

This application claims priority from Korean Patent Application No. 10-2011-0025392, filed on Mar. 22, 2011, in the Korean Intellectual Property Office, the disclosure of which is incorporated herein in its entirety by reference.

### BACKGROUND

1. Field

Apparatuses consistent with exemplary embodiments relate to temperature control for sample storage.

2. Description of the Related Art

Bio equipment is a scientific instrument used in researching phenomena of life, and specifically, is used to study and understand biological phenomena of stages of molecules, cells, and individuals using physical or chemical principles.

More specifically, bio equipment is used to conduct researches in bio technology such as gene modification techniques (e.g., recombination deoxyribonucleic acid (DNA) technique, gene cure, cloning, and antisense), biological sample analysis techniques using absorption, phosphorescence, and Raman spectroscopy, patterning of living bodies, gene chips, polymerase chain reaction (PCR), gene map, and protein engineering, etc. In addition to biology, bio equipment is also widely used in various technological fields such as chemistry, physics, electronics, mechanics, etc. and may be advanced through cooperation between these technological fields.

Bio equipment may be classified into six specific fields, namely, sample manufacture, bio separation, bio spectroscopy, bio patterning, cell technology, and mass spectrometry.

In regard to conducting researches in biotechnology, maintaining temperatures of bio samples to be uniform is a key factor, and the uniform temperatures are used for reliable research results. In addition, if the temperatures of samples are maintained to be uniform, it may be useful to extend the storage period of samples produced in a manufacture process.

Thus, demands for an apparatus for maintaining sample temperatures to be uniform are rapidly increasing. In detail, in studies on biological phenomena and applications in bio-tech industries, an amount of processing samples processed per unit time using a single container having several wells is increasing. If there is deviation in temperatures of solutions in the wells of the container, results of data of samples that are experimented upon are unreliable, and storage periods of the manufactured samples may vary, which has become a main issue in the field. An example of such issues is storage of specimens, from which nucleic acid extraction is completed before DNA amplification using a PCR device, for purposes of quantitative/qualitative examination of human immunodeficiency virus (HIV), hepatitis C virus (HCV), hepatitis B virus (HBV), etc., at 4° C.

In apparatuses for maintaining temperature according to the related art, a problem of deviation in temperatures between solutions in large-surface multi-wells containing samples occurs away from a heat source such as a heating/cooling device or a thermoelectric device.

### SUMMARY

One or more embodiments provide a temperature control apparatus for sample storage in which the temperatures of samples in large-surface multi-wells may be maintained to be uniform.

According to an aspect of an exemplary embodiment, there is provided a temperature control apparatus including: a well block comprising at least one accommodation groove accommodating at least one container for containing at least one sample therein, respectively; and a temperature control unit controlling a respective temperature of the at least one sample to be uniform, wherein the temperature control unit includes: a heat source portion generating heat or cold; and a heat transfer object transferring the heat or the cold of the heat source portion to the well block, wherein the heat transfer object controls the heat or the cold to be transferred substantially uniformly to an entire portion of the heat transfer object, and controls the respective temperature of the at least one sample to be uniform by transferring the heat or the cold to the well block.

The at least one accommodation groove comprises two or more accommodation grooves which are arranged in a plurality of rows and columns.

The heat transfer object may be disposed between the well block and the heat source portion.

The heat transfer object may include at least one heat pipe.

The heat transfer object may include at least one heat transfer unit which is arranged to correspond to the at least one accommodation groove, respectively.

The at least one accommodation groove may include two or more accommodation grooves which are arranged in a plurality of rows and columns. The heat transfer object may include two or more heat transfer units. Each of the heat transfer units may be arranged between two adjacent accommodation grooves.

The heat transfer object may be disposed inside the well block.

When a surface of the heat source portion facing the well block is heated, an opposite surface of the heat source portion may be cooled, and when the surface of the heat source portion facing the well block is cooled, the opposite surface of the heat source portion may be heated.

The heat source portion may be formed of a Peltier device.

The temperature control unit may further comprise a heat sink contacting a side of the heat source portion.

The temperature control unit may further comprise a cooling fan disposed on a side of the heat source portion.

The temperature control unit may further comprise: a temperature sensor measuring a temperature of the well block; and a controller controlling the heat source portion to analyze the temperature of the well block that is measured by using the temperature sensor and to control the temperature of the well block to be uniform.

The temperature control apparatus may further comprise an adhesion member disposed between the heat transfer object and the heat source portion, wherein the adhesion member fills an aperture between the heat transfer object and the heat source portion, and the heat or the cold of the heat source portion is transferred to the heat transfer object via the adhesion member.

The temperature control apparatus may further comprise an adhesion member disposed between the well block and the heat transfer object, wherein the adhesion member fills an aperture between the heat transfer object and the well block, and the heat or the cold transferred from the heat source portion to the heat transfer object is transferred to the well block via the adhesion member.

### BRIEF DESCRIPTION OF THE DRAWINGS

The above and other aspects will become more apparent by describing in detail exemplary embodiments thereof with reference to the attached drawings, in which:

FIG. 1 is an exploded perspective view schematically illustrating a temperature control apparatus for sample storage, according to an exemplary embodiment;

FIG. 2 is a perspective view of a heat transfer object illustrated in FIG. 1, according to an exemplary embodiment;

FIG. 3 is a cross-sectional view of a heat pipe illustrated in FIG. 2, according to an exemplary embodiment;

FIG. 4 is a cross-sectional view schematically illustrating a temperature control apparatus for sample storage, according to another exemplary embodiment; and

FIG. 5 is a cross-sectional view schematically illustrating a temperature control apparatus for sample storage, according to another exemplary embodiment.

### DETAILED DESCRIPTION OF EXEMPLARY EMBODIMENTS

An inventive concept will now be described more fully with reference to the accompanying drawings, in which exemplary embodiments are shown. Expressions such as “at least one of,” when preceding a list of elements, modify the entire list of elements and do not modify the individual elements of the list.

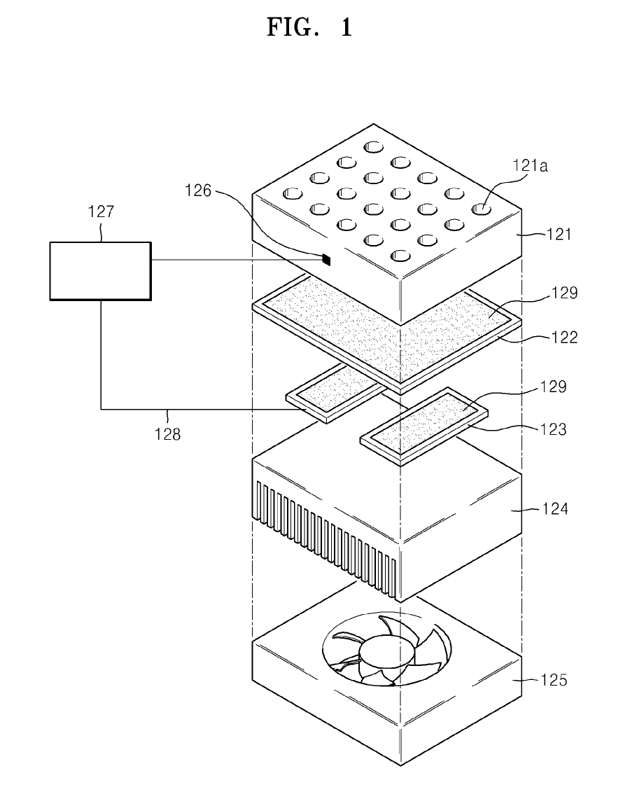

FIG. 1 is an exploded perspective view schematically illustrating a temperature control apparatus for sample storage, according to an exemplary embodiment.

Referring to FIG. 1, the temperature control apparatus may include a well block 121 and a temperature control unit.

The temperature control unit may include a heat transfer object 122, a heat source portion 123, a heat sink 124, a cooling fan 125, a temperature sensor 126, and a controller 127.

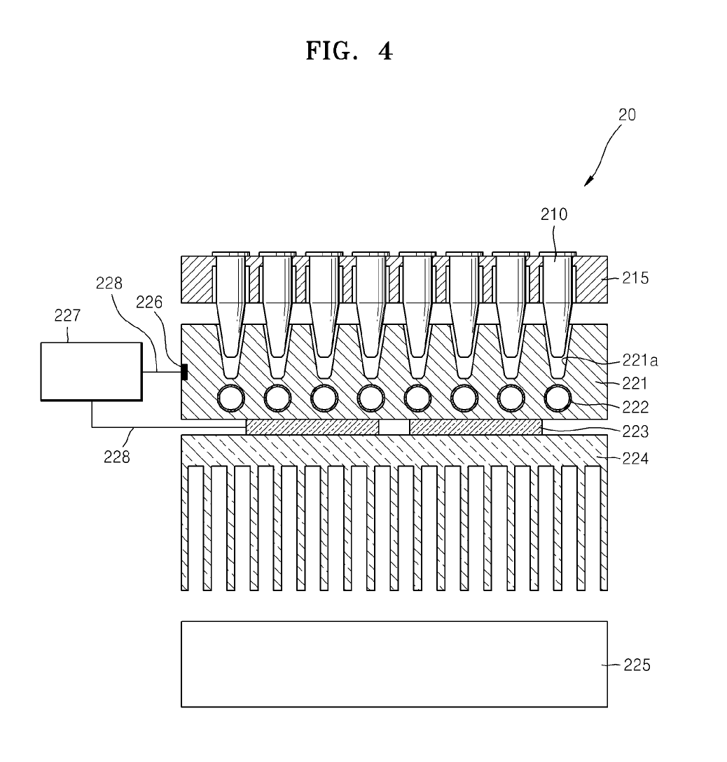

The well block 121 may include at least one accommodation groove 121a accommodating containers 210 (see FIG. 4) for containing samples. The accommodation grooves 121a are concavely formed toward an inner portion of the well block 121 such that the containers 210 may be inserted into the accommodation grooves 121a. The accommodation grooves 121a may be formed in the well block 121 in a plurality of columns and rows. The number of accommodation grooves 121a is determined by the number of containers 210 to be inserted therein. In general, containers such as 24DWP, 48DWP, 96DWP, and 384DWP (standards) are used, and thus, the number of accommodation grooves 121a of the well block 121 may vary according to the standard of containers.

The temperature control unit may measure a temperature of the well block 121, and heat or cool the well block 121 to control the temperatures of samples in the containers 210 (see FIG. 4) accommodated in the well block 121 to be uniform. The temperature control unit may include the heat transfer object 122, the heat source portion 123, the heat sink 124, the cooling fan 125, the temperature sensor 126, and the controller 127.

The heat transfer object 122 may be disposed below the well block 121. The heat transfer object 122 transfers heat generated by the heat source portion 123 to the well block 121. Since samples contained in the containers 210 (see FIG. 4) accommodated in the well block 121 have to be maintained at a uniform temperature, the heat transfer object 122 may preferably, but not necessarily, be formed of a medium capable of uniformly transferring heat to the entire well block 121. The heat transfer object 122 may be formed of a heat pipe.

The well block 121 and the heat transfer object 122 may be adhered to each other by using an adhesion member 129. The adhesion member 129 may be a thermally conductive bond. The adhesion member 129 is disposed between the well block 121 and the heat transfer object 122, and fills an aperture between the well block 121 and the heat source portion 123 to maximize heat transfer efficiency from the heat transfer object 122 to the well block 121.

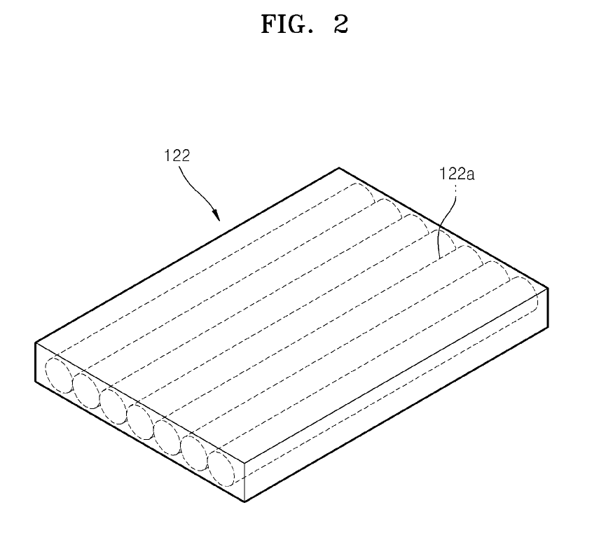

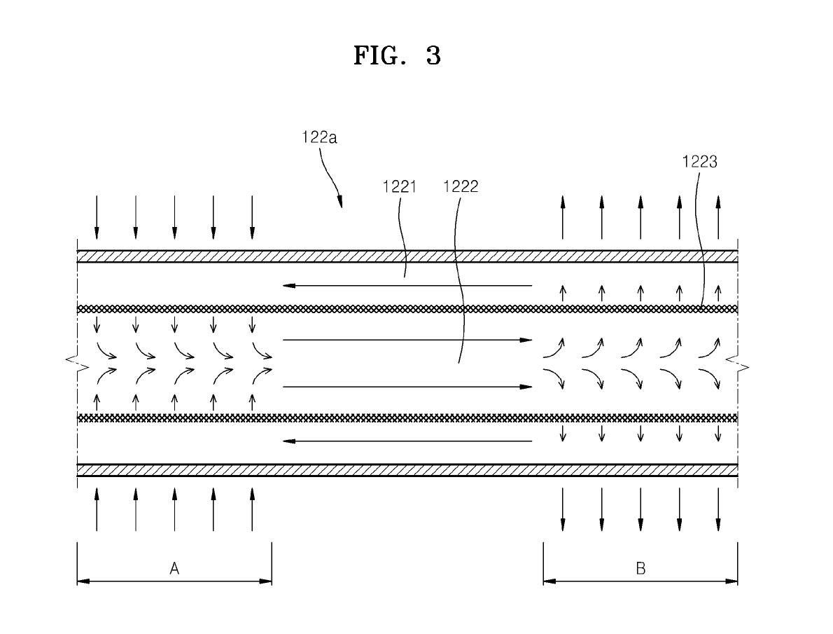

The heat transfer object 122 may be formed of a plurality of heat pipes 122a as illustrated in FIG. 2. The heat pipes 122a are used to transfer heat generated by the heat source portion 123 at an ultrahigh speed so that the entire area of the well block 121 is controlled to be at a uniform temperature. FIG. 3 is a schematic cross-sectional view of the heat pipes 122a. Referring to FIG. 3, the heat pipes 122a includes a first passage 1221, a second passage 1222, and a wick 1223. The wick 1223 is disposed between the first passage 1221 and the second passage 1222 to divide the first passage 1221 and the second passage 1222. The first passage 1221 is disposed on outer portions of the second passage 1222. A heat transfer medium in the form of a liquid moves in the first passage 1221, and a heat transfer medium in the form of a gas moves in the second passage 1222. Alternatively, the heat transfer medium in the form of a liquid moves in the second passage 1222, and a heat transfer medium in the form of a gas moves in the first passage 1221. In the heat pipes 122a, a heat transfer medium repeats gasification and liquefaction to substantially uniformly transferring heat to the entire heat pipes 122a.

In detail, a heat transfer medium which is in a liquid form is gasified in a first portion A of the heat pipe 122a to which heat is transferred from the heat source portion 123, and the gasified heat transfer medium moves from the first passage 1221 to the second passage 1222 via the wick 1223. The heat transfer medium in the form of gas, which has arrived at the second passage 1222, then moves to a second portion B which is not heated, along the second passage 1222. In the second portion B, the heat transfer medium in the form of gas is liquefied by emitting heat. Here, the heat emitted by the heat transfer medium as it is being liquefied is transferred to the well block 121. The heat transfer medium in the liquid form then moves from the second passage 1222 to the first passage 1221 in the second portion B. The heat transfer medium that has moved to the first passage 1221 moves again to the first portion A along the first passage 1221.

As described above, as heat is quickly transferred through liquefaction and gasification of the heat transfer medium through the heat pipes 122a, the heat generated in the heat source portion 123 is uniformly transferred to the entire well block 121, thereby maintaining uniform temperatures of samples in containers accommodated in the well block 121.

The heat source portion 123 may heat or cool the well block 121. The heat source portion 123 may generate heat or absorb heat, to thereby heat or cool the well block 121. The heat generated by or absorbed by the heat source portion 123 is used to heat or cool the well block 121 via the heat transfer object 122.

The heat transfer object 122 and the heat source portion 123 may be adhered to each other using the adhesion member 129. The adhesion member 129 may be a thermally conductive bond. The adhesion member 129 is disposed between the heat transfer object 122 and the heat source portion 123, and fills an aperture between the well block 121 and the heat source portion 123 to maximize heat transfer efficiency from the heat transfer object 122 to the well block 121.

The heat source portion 123 may be formed of a medium having a characteristic that when a first surface thereof is heated, a second surface thereof is cooled, and when the first surface is cooled, the second surface is heated. For example, the heat source portion 123 may be formed of a Peltier device. A Peltier device is an electricity/heat converting device using the Peltier effect, which is a heat transfer phenomenon that when two types of metals are bonded and a current is applied thereto, heat is generated by or absorbed by a bonding portion of the two metals. Accordingly, as the controller 127 applies a current to the heat source portion 123 via an electrical wiring 128, a temperature of the well block 121 may increase or decrease to thereby control the temperatures of the containers 210.

The temperature sensor 126 may be installed in the well block 121, and the controller 127 may control a temperature of the well block 121 based on a sensing signal of the temperature sensor 126.

The controller 127 may determine whether the temperature of the well block 121, which is measured by using the temperature sensor 126, is maintained at a predetermined level, and may control the heat source portion 123 such that the well block 121 maintains a uniform temperature. The controller 127 may be, for example, a semiconductor chip or a circuit board using a semiconductor chip.

The temperature control apparatus 10 according to the current embodiment for sample storage may further include the heat sink 124 formed of a heat transferring material and contacting the first surface of the heat source portion 123. The heat sink 124 may perform an auxiliary function of transferring heat generated by the heat source portion 123 to the outside for fast cooling. The heat sink 124 may be formed of a thermal conductive metal such as aluminum or copper. By including the heat sink 124, a cooling effect may be obtained due to a natural convection current. Other than the illustrated structure, the heat sink 124 may also have a well-known heat pipe structure.

Other various techniques may be used to supplement a cooling effect besides including the heat sink 124. For example, the cooling fan 125 for ventilating the air may be included or a cooling pipe through which a cooling fluid flows may be included.

FIG. 4 is a cross-sectional view schematically illustrating a temperature control apparatus 20 for sample storage, according to another exemplary embodiment.

Referring to FIG. 4, the temperature control apparatus 20 may include a well block 221 and a temperature control unit. The temperature control unit may include heat transfer objects 222 a heat source portion 223, a heat sink 224, a cooling fan 225, a temperature sensor 226, and a controller 227.

Containers 210 may be inserted into accommodation grooves 221a of the well block 221. The containers 210 may be formed of a material such as a transparent plastic or glass. For example, a nucleic acid sample, which is to be amplified, may be contained in the containers 210. An upper portion of the containers 210 is supported by using a support plate 215. The containers 210 and the support plate 215 may be formed as a single unit. The containers 210 are inserted into the accommodation grooves 221a of the well block 221.

The temperature sensor 226 may be installed at the well block 221, and the controller 227 may control the temperatures of the containers 210 based on a sensing signal of the temperature sensor 226. The controller 227 may control the heat source portion 223 to generate heat or to cool based on a temperature of the well block 221 so that the temperature of the well block 221 is controlled to be uniform.

The heat transfer objects 222 may be disposed inside the well block 221 to correspond to the accommodation grooves 221a. The accommodation grooves 221a may be arranged in the well block 221 in a plurality of columns and rows. In the temperature control apparatus 20 according to the current exemplary embodiment, the heat transfer objects 222 may be arranged to correspond to the accommodation grooves 221a that are arranged in series. For example, the heat transfer object 222 may be in a bar form and be separated from concave portions of the accommodation grooves 221a that are serially arranged. Intervals between the heat transfer objects 222 below the accommodation grooves 221a may be identical. As the heat transfer objects 222 are arranged at the same intervals as the accommodation grooves 221a are, the temperatures of the containers 210 accommodated in the well block 221 may be controlled to be uniform. The heat transfer objects 222 according to the current exemplary embodiment may be heat pipes.

The heat source portion 223 may heat or cool the well block 221. The heat source portion 223 may generate heat or absorb heat to heat or cool the well block 221, respectively. The heat generated by or absorbed by using the heat source portion 223 is used to heat or cool the well block 221 via the heat transfer objects 222. The heat transfer objects 222 and the heat source portion 223 may be adhered to each other using a thermal conductive bond.

The heat source portion 223 may be formed of a medium having a characteristic that when a first surface thereof is heated, a second surface thereof is cooled, and when the first surface is cooled, the second surface is heated). For example, the heat source portion 223 may be formed of a Peltier device. A Peltier device is an electricity/heat converting device using the Peltier effect, which is a heat transfer phenomenon that when two types of metals are bonded and a current is applied thereto, heat is generated by or absorbed by a bonding portion of the two metals. Accordingly, as the controller 227 applies a current to the heat source portion 223 via an electrical wiring 228, a temperature of the well block 221 may increase or decrease to thereby control the temperatures of the containers 210.

The heat sink 224 may be disposed below the heat source portion 223. The heat sink 224 may perform an auxiliary function of transferring heat generated by the heat source portion 223 to the outside for fast cooling. For example, the heat sink 224 may be formed of a thermal conductive metal such as aluminum or copper. When the first surface of the heat source portion 223, that is, a surface facing the well block 221, performs the function of cooling, the second surface of the heat source portion 223 is heated, and thus, the heat sink 224 dissipates heat of the second surface of the heat source portion 223.

The cooling fan 225 may be disposed under the heat sink 224. When the first surface of the heat source portion 223 is cooled, the second surface of the heat source portion 223 is heated, and in this case, the cooling fan 225 operates to thereby cool the second surface of the heat source portion 223 with the heat sink 224. However, when the first surface of the heat source portion 223 is heated and the second surface thereof is cooled, the cooling fan 225 may not operate.

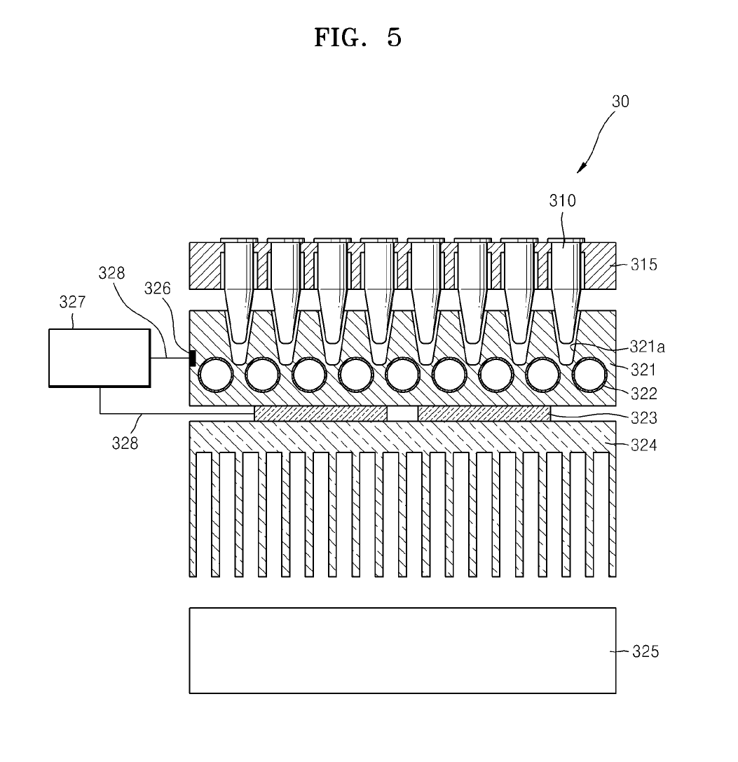

FIG. 5 is a cross-sectional view schematically illustrating a temperature control apparatus 30 for sample storage, according to another exemplary embodiment.

Referring to FIG. 5, the temperature control apparatus 30 may include a well block 321 and a temperature control unit. The temperature control unit may include a plurality of heat transfer objects 322, a heat source portion 323, a heat sink 324, a cooling can 325, a temperature sensor 326, and a controller 327.

A plurality of containers 310 may be inserted into a plurality of accommodation grooves 321a of the well block 321. The containers 310 may be formed of a material such as a transparent plastic or glass. For example, a nucleic acid sample, which is to be amplified, may be contained in the containers 310. An upper portion of the containers 310 is supported by using a support plate 315. The containers 310 are inserted into the accommodation grooves 321a of the well block 321.

The temperature sensor 326 may be installed at the well block 321, and the controller 327 may control the temperatures of the containers 310 based on a sensing signal of the temperature sensor 326. The controller 327 may control the heat source portion 323 to generate heat or to cool based on a temperature of the well block 321 so that the temperature of the well block 321 is controlled to be uniform.

The heat transfer objects 332 may be disposed inside the well block 321 to correspond to the accommodation grooves 321a. The accommodation grooves 321a may be arranged in the well block 321 in a plurality of columns and rows. In the temperature control apparatus 30 according to the current embodiment, the heat transfer objects 322 may be arranged in respective spaces between the adjacent accommodation grooves 321a. For example, the heat transfer objects 322 may be in a bar form and may be separated from the accommodation grooves 321a at the same intervals to be between the accommodation grooves 321a. As the heat transfer objects 322 are arranged at the same intervals as the accommodation grooves 321a are, the temperatures of the containers 310 accommodated in the well block 321 may be controlled to be uniform. The heat transfer objects 322 according to the current embodiment may be heat pipes.

The heat source portion 323 may heat or cool the well block 321. The heat source portion 323 may generate heat or absorb heat to heat or cool the well block 321, respectively. The heat generated by or absorbed by the heat source portion 323 is used to heat or cool the well block 321 via the heat transfer objects 322. The heat transfer objects 322 and the heat source portion 323 may be adhered to each other using a thermal conductive bond.

The heat source portion 323 may be formed of a medium having a characteristic that when a first surface thereof is heated, a second surface thereof is cooled, or when the first surface is cooled, the second surface is heated. For example, the heat source portion 323 may be formed of a Peltier device. A Peltier device is an electricity/heat converting device using the Peltier effect, which is a heat transfer phenomenon that when two types of metals are bonded and a current is applied thereto, heat is generated by or absorbed by a bonding portion of the two metals. Accordingly, as the controller 327 applies a current to the heat source portion 323 via an electrical wiring 328, a temperature of the well block 321 may increase or decrease to thereby control the temperatures of the containers 310.

The heat sink 324 may be disposed below the heat source portion 323. The heat sink 324 may perform an auxiliary function of transferring heat generated by the heat source portion 323 to the outside for fast cooling. For example, the heat sink 324 may be formed of a thermal conductive metal such as aluminum or copper. When the first surface of the heat source portion 323, that is, a surface facing the well block 321, performs the function of cooling, the second surface of the heat source portion 323 is heated, and thus, the heat sink 324 dissipates heat of the second surface of the heat source portion 323.

The cooling fan 325 may be disposed under the heat sink 324. When the first surface of the heat source portion 323 is cooled, the second surface of the heat source portion 323 is heated, and in this case, the cooling fan 325 operates to thereby cool the second surface of the heat source portion 323 with the heat sink 324. However, when the first surface of the heat source portion 323 is heated and the second surface thereof is cooled, the cooling fan 325 may not operate.

According to the exemplary embodiments, the temperatures of samples stored in well blocks may be controlled to be uniform.

While the inventive concept has been particularly shown and described with reference to exemplary embodiments thereof, it will be understood by those of ordinary skill in the art that various changes in form and details may be made therein without departing from the spirit and scope of the inventive concept as defined by the following claims.

What is claimed is:

1. A temperature control apparatus comprising:
a well block comprising at least one accommodation groove accommodating at least one container for containing at least one sample therein, respectively; and
a temperature control unit controlling a respective temperature of the at least one sample to be uniform,
wherein the temperature control unit comprises:
a heat source portion generating heat or cold; and
a heat transfer object transferring the heat or the cold of the heat source portion to the well block,
wherein the heat transfer object controls the heat or the cold to be transferred substantially uniformly to an entire portion of the heat transfer object, and controls the respective temperature of the at least one sample to be uniform by transferring the heat or the cold to the well block.

2. The temperature control apparatus of claim 1, wherein the at least one accommodation groove comprises two or more accommodation grooves which are arranged in a plurality of rows and columns.

3. The temperature control apparatus of claim 1, wherein the heat transfer object is disposed between the well block and the heat source portion.

4. The temperature control apparatus of claim 1, wherein the heat transfer object comprises at least one heat pipe.

5. The temperature control apparatus of claim 4, wherein an inside of the at least one heat pipe comprises:
a first passage which is disposed in a longitudinal direction of the at least one heat pipe and in which one of liquid and gas moves in one direction;
a second passage which is disposed in the longitudinal direction and encompassed by the first passage, and in which the other of the liquid and the gas moves in the other direction; and
a wick which divides the first passage and the second passage,
wherein the heat or the cold is transferred between one end and the other end of the pipe in the longitudinal direction through the liquid and the gas.

6. The temperature control apparatus of claim 5, wherein, at the one end of the pipe, the liquid is gasified by the heat to generate the gas which moves to the other end in the second passage,
wherein, at the other end, the gas which moves from the one end is liquefied by emitting the heat, and
wherein the liquid, which is liquefied gas, moves from the other end to the one end in the first passage, and the heat of the liquefied gas is transferred to the well block.

7. The temperature control apparatus of claim 1, wherein the heat transfer object comprises at least one heat transfer unit which is arranged to correspond to the at least one accommodation groove, respectively.

8. The temperature control apparatus of claim 1, wherein the at least one accommodation groove comprises two or more accommodation grooves which are arranged in a plurality of rows and columns,
wherein the heat transfer object comprises two or more heat transfer units, and
wherein each of the heat transfer unit is arranged between two adjacent accommodation grooves of the two or more accommodation grooves.

9. The temperature control apparatus of claim 1, wherein the heat source portion is configured such that, when a surface of the heat source portion facing the well block is heated, an opposite surface of the heat source portion is cooled, and when the surface of the heat source portion facing the well block is cooled, the opposite surface of the heat source portion is heated.

10. The temperature control apparatus of claim 9, wherein the temperature control unit further comprises a heat sink connected to the opposite surface of the heat source portion, and
wherein when the surface of the heat source portion facing the well block is cooled, the heat of the opposite surface of the heat source portion is dissipated through the heat sink.

11. The temperature control apparatus of claim 1, wherein the heat source portion is formed of a Peltier device.

12. The temperature control apparatus of claim 1, wherein the temperature control unit further comprises:
a temperature sensor measuring a temperature of the well block; and
a controller controlling the heat source portion to analyze the temperature of the well block that is measured by using the temperature sensor and to control the temperature of the well block to be uniform.

13. The temperature control apparatus of claim 1, further comprising an adhesion member disposed between the heat transfer object and the heat source portion,
wherein the adhesion member fills an aperture between the heat transfer object and the heat source portion, and the heat or the cold of the heat source portion is transferred to the heat transfer object via the adhesion member.

14. The temperature control apparatus of claim 1, wherein the heat source portion selectively generates the heat or the cold,
wherein the heat transfer object selectively transfers the heat or the cold of the heat source portion to the well block, and
wherein the heat transfer object selectively controls the heat or cold to be transferred substantially uniformly to an entire portion of the heat transfer object, and controls the respective temperature of the at least one sample to be uniform by selectively transferring the heat or code to the well block.

15. The temperature control apparatus of claim 1, wherein the at least one accommodation groove comprises two or more accommodation grooves accommodating two or more containers for containing at least one sample, therein, respectively,
wherein the temperature control unit controls temperatures of the two or more containers to be uniform using the heat or the cold generated at the heat source portion and transferred to the well block through the heat transfer object.

16. The temperature control apparatus of claim 15, wherein the heat source portion selectively generates the heat or the cold,
wherein the heat transfer object selectively transfers the heat or the cold of the heat source portion to the well block, and
wherein the heat transfer object selectively controls the heat or cold to be transferred substantially uniformly to an entire portion of the heat transfer object, and controls the at least one temperature of the respective at least one sample to be uniform by selectively transferring the heat or code to the well block.
